(19) United States
(12) Patent Application Publication
(10) Pub. No.: US 2008/0098807 A1
(43) Pub. Date: May 1, 2008

(54) Ultrasonic Phase Shift Moisture Sensing System With Temperature Compensation

(75) Inventors: Colin J. Byrne, Ypsilanti, MI (US); Brent W. Pankey, Brighton, MI (US); Mitchell Max Rohde, Saline, MI (US); Karl Grosh, Ann Arbor, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: AGC AUTOMOTIVE AMERICAS R&D, INC., Ypsilanti, MI (US)

(21) Appl. No.: 11/554,265

(22) Filed: Oct. 30, 2006

(51) Int. Cl. G01W 1/00; G01N 5/02; G08B 21/00

(52) U.S. Cl. 73/170.17; 73/73; 340/602

(57) ABSTRACT

A sensing system computes an amount of moisture on a surface of a substrate, such as a window of a vehicle. The sensing system includes a transmitter which produces a wave to propagate through the substrate. A receiver receives the wave which propagated through the substrate. A phase shift detection circuit measures a phase shift between signals representing the transmitted and received wave. A temperature sensor senses a temperature of the substrate. A controller, in communication with the phase shift detection circuit and the temperature sensor, calculates the amount of moisture on the surface based on the phase shift and the temperature of the substrate. A wiper motor and wiper blade may then be actuated automatically based on the amount of moisture calculated to clear the moisture on the substrate.

### BACKGROUND OF THE INVENTION

1. Field of the Invention

The subject invention relates to a sensing system for sensing an amount of moisture on a surface of a substrate.

2. Description of the Related Art

Various sensing systems for detecting moisture on a surface of a window are known in the art. One example of such a system is disclosed in U.S. Pat. No. 5,432,415 (the '415 patent). The '415 patent discloses a sensing system for sensing moisture on the surface of a window. The system includes a control circuit including a signal generator. The signal generator generates a transmitter signal. A transmitter is electrically connected to the signal generator and operatively connected to the window for generating an ultrasonic wave which travels through the window. A receiver is also operatively connected to the window at a point distant from the transmitter. The receiver receives the wave traveling through the window and generates a receiver signal corresponding to the wave. A comparator circuit is electrically connected to the receiver and the signal generator. The comparator circuit compares the receiver signal to the transmitter signal to determine a phase shift between the signals. The amount of phase shift can then be used to approximate an amount of moisture on the surface. A wiper can then be actuated to clean the moisture from the surface.

Although the sensing system of the '415 patent can provide an approximation of moisture on the surface, it lacks the ability to finely sense the amount of moisture on the surface because it does not incorporate the ability to compensate for factors that affect phase shift other than moisture by accounting for factors other than moisture. An example of such a factor is the temperature of the window. If not properly incorporated in the moisture estimation system calculation, the temperature of the window may cause either a “false positive” for moisture on the surface and needlessly operate the wipers or a “false negative” and not operate the wipers when there is moisture on the surface. Hence, there remains an opportunity for a method of determining the amount of moisture on the surface that compensates for the temperature of the surface in determining the amount of moisture on the surface and thus yields a more robust system.

### SUMMARY OF THE INVENTION AND ADVANTAGES

The subject invention provides a sensing system for sensing an amount of moisture on a surface of a substrate. A signal generator generates a transmitter signal. A transmitter is operatively connected to the substrate and electrically connected to the signal generator for producing a wave corresponding to the transmitter signal to propagate through the substrate. A receiver is operatively connected to the substrate and spaced apart from the transmitter for receiving the wave and generating a receiver signal corresponding to the wave. A phase shift detection circuit is electrically connected to the receiver and the signal generator. The phase shift detection circuit measures a phase shift between the transmitter signal and the receiver signal. A temperature sensor senses a temperature of the substrate. A controller, in communication with the phase shift detection circuit and the temperature sensor, determines the amount of moisture on the surface based on the phase shift and the temperature of the substrate. The subject invention also provides a window assembly integrating the sensing system described above and a substrate having an inner surface and an outer surface.

The sensing system of the subject invention compensates for the temperature of the substrate when sensing the amount of moisture on the surface of the substrate. This compensation allows for a more accurate calculation of the amount of moisture than traditional rain sensing systems. Consequently, when used to activate a wiper blade on a vehicle, the sensing system of the present invention prevents unnecessary overwiping, where the wiper blade activates too often (including when no moisture is present at all), and underwiping, where the wiper blade does not activate often enough.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a combination block diagram and partial cross-sectional view of a preferred embodiment of a sensing system showing electrical and communicative connections between various devices of the sensing system, connection of a transmitter and a receiver to a windshield of a vehicle, and connection to a wiper blade for wiping the windshield;

FIG. 2 is a front view of the vehicle showing the windshield with the transmitter and receiver mounted at opposite sides of the windshield mid-way between a top and a bottom of the windshield;

FIG. 3 is a front view of the vehicle with the transmitter mounted at a top and center of the windshield and the receiver mounted near a driver's side mid-way between the top and bottom;

FIG. 4 is a front view of the vehicle with the transmitter and receiver mounted at opposite sides of the windshield near the top of the windshield;

FIG. 5 is a front view of the vehicle with the transmitter and receiver mounted at a top and center of the windshield; and

FIG. 6 is a graph showing an illustrative example of a phase shift between a transmitter signal and a receiver signal.

### DETAILED DESCRIPTION OF THE INVENTION

Referring to the Figures, wherein like numerals indicate corresponding parts throughout the several views, a sensing system 10 for sensing an amount of moisture 12 on an outer surface 14 of a substrate 16 is shown.

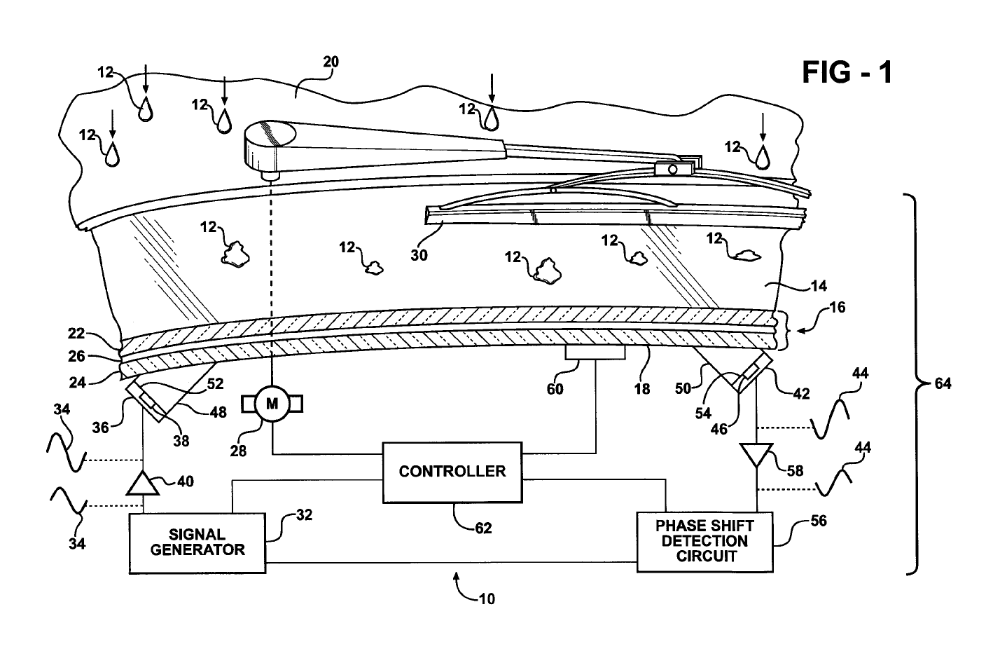

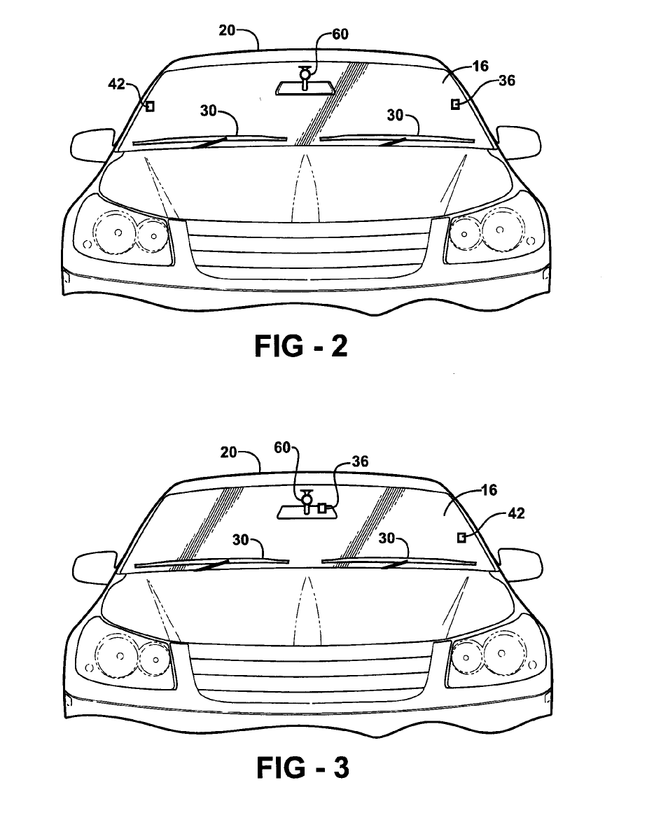

Referring to FIG. 1, the substrate 16 defines an inner surface 18 and an outer surface 14. In a preferred embodiment, the substrate 16 is further defined as at least one pane of glass and is commonly referred to as a window glazing. As shown in FIG. 2, the substrate 16 may be incorporated as part of a vehicle 20. The outer surface 14 of the substrate 16 generally faces the outside of the vehicle 20, i.e., the side that exposed to the elements, such as rain or snow. The inner surface 18 of the substrate 16 generally faces the inside of the vehicle 20, i.e., the passenger compartment. Of course, the terms inner surface 18 and outer surface 14 are used merely for convenience and could be reversed or other terms could be used as is realized by those skilled in the art.

Those skilled in the art also appreciate that the substrate 16 may be incorporated in the vehicle 20 as a windshield, a back window, a side window, a sun roof, etc. In the case of the back window or the side window, the substrate 16 is typically a single pane of glass. For a windshield, the substrate 16 is typically a first pane of glass 22 and a second pane of glass 24 sandwiching a transparent polymer layer 26, such as polyvinyl butyral (PVB). Preferably, the panes of glass are further defined generally as automotive glass, and more specifically as soda-lime-silica glass. Those skilled in the art also appreciate that materials, other than glass, may be used to form the substrate 16, e.g., resin, polycarbonate, acrylic, etc.

The sensing system 10 of the preferred embodiment may also include a wiper motor 28. At least one wiper blade 30 is operatively connected to the wiper motor 28. When the wiper motor 28 is actuated, the wiper blade(s) 30 move across the substrate 16 to remove the moisture 12 (and other foreign objects, such as dust, dirt, etc.) from the substrate 16.

The sensing system 10 includes a signal generator 32 for generating a transmitter signal 34. Preferably, the signal generator 32 generates a sinusoidal waveform, however, those skilled in the art realize that other waveforms, such as triangular waves, square waves, or saw tooth waves, may also be generated. In the preferred embodiment, the signal generator 32 includes an oscillator (not shown) which produces a square wave electrically connected to an active low pass filter (not shown) which removes the higher order harmonics of the square wave to produce the sinusoidal waveform. Of course, other techniques are known to those skilled in the art to produce the sinusoidal waveform. The transmitter signal 34 preferably has a frequency in the ultrasonic range. Specifically, the frequency is preferably greater than 20 kHz, which is the upper range of human hearing, and more preferably in the range of 100 to 1,200 kHz. However, those skilled in the art realize other frequencies, including those in an audible range (between 20-20,000 Hz) may also be utilized, based on the size and composition of the substrate and other factors. The transmitter signal 34 may be pulsed, i.e., turned on and off, or continuous, i.e., always on.

A transmitter 36 is electrically connected to the signal generator 32 for producing a wave corresponding to the transmitter signal 34. The transmitter 36 is operatively connected to the inner surface 18 of the substrate 16 such that the wave propagates through the substrate 16. This propagation of the wave causes the substrate 16 to vibrate, although imperceptible to human senses. In the preferred embodiment, the transmitter 36 includes a transmitting piezoelectric element 38. The transmitting piezoelectric element 38 physically actuates in response to the transmitter signal 34 to generate the wave in the substrate 16. Of course, those skilled in the art realize other techniques to generate the wave in the substrate 16, apart from piezoelectrics.

Also in the preferred embodiment, a transmitter amplifier 40 is electrically connected between the signal generator 32 and the transmitter 36 for amplifying the transmitter signal 34. In the preferred embodiment, the transmitter amplifier 40 is a model number AD826 manufactured by Analog Devices, Inc. of Norwood, Mass., however, other suitable devices may be implemented. Those skilled in the art realize that the transmitter amplifier 40 may be a component separate from the signal generator 32 or may be integrated with either the signal generator 32 or the transmitter 36. Furthermore, the signal generator 32, transmitter amplifier 40, and transmitter 36 may be integrated together in a single unit.

A receiver 42 is operatively connected to the inner surface 18 of the substrate 16 and spaced apart from the transmitter 36. The receiver 42 receives the wave produced by the transmitter 36. The receiver 42 generates a receiver signal 44 corresponding to the received wave. In the preferred embodiment, the receiver 42 includes a receiving piezoelectric element 46. When actuated, the receiving piezoelectric element 46 generates the receiver signal 44. As with the transmitter 36, those skilled in the art realize other techniques to generate the receiver signal 44, apart from piezoelectrics. Those skilled in the art also realize that the transmitter 36 and the receiver 42 may each be a transducer, capable of transmitting or receiving. Thus, the transmitter 36 and receiver 42 may be an identical device, but simply operated in a different way.

Sizing and material selection of the piezoelectric elements 38, 46 is dependent on the specifications of the substrate, distance between the transmitter 36 and receiver 42, and other factors. In the preferred embodiment, the piezoelectric elements 38, 46 are manufactured by American Piezo Ceramics, Inc. (APC International, Ltd.) of Mackeyville, Pa. The piezoelectric elements 38, 46 of the preferred embodiment have a cross-sectional area of about 150 mm² and a thickness which is dependent of the frequency of the transmitter signal 34. Of course, those skilled in the art realize other suitable sizes, materials, and manufacturers for implementing the piezoelectric elements 38, 46.

The sensor system 10 may also include a transmitter coupler component 48 and a receiver coupler component 50. The transmitter coupler component 48 is disposed between the transmitter 36 and the inner surface 18 of the substrate 16 and the receiver coupler component 50 is disposed between the inner surface 18 of substrate 16 and the receiver 42. The transmitter coupler component 48 separates the transmitter 36 from the substrate 16 while allowing propagation of the wave from the transmitter 36 to the substrate 16. Likewise, the receiver coupler component 50 separates the receiver 42 from the substrate 16 while allowing propagation of the wave from the substrate 16 to the receiver 42. In the preferred embodiment, the coupler components 48, 50 are formed of acrylic, however other suitable materials for allowing wave propagation may also be utilized.

The transmitter coupler component 48 includes a first directing surface 52 angled relative toward the receiver 42 for directing the transmitter 36 toward the receiver 42. Likewise, the receiver coupler component 50 includes a second directing surface 54 angled relative toward the transmitter 36 for directing the receiver 42 toward the transmitter 36. Angling of the transmitter 36 and the receiver 42 towards one another results in better propagation of the wave from the transmitter 36 and better reception of the wave by the receiver 42. In the preferred embodiment, each coupler component has a wedge shape. The angle of the first and second directing surface 52, 54 is preferably in the range of 10-45 degrees from a line that is parallel to the inner surface 18 of the substrate 16 and is based, in part, on the composition of the substrate and the couple. Preferably, the angle of the first and second directing surface are about identical. The transmitter and receiver coupler components 48, 50 set the phase velocity of the wave, compensate for thermal expansion of the substrate 16, and provide impedance matching.

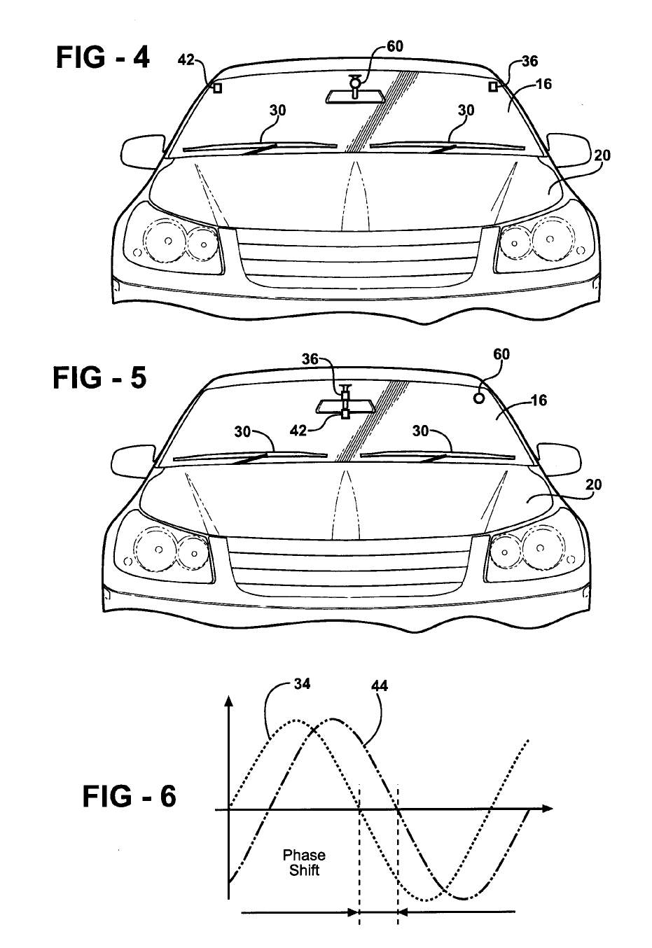

As shown in FIGS. 2-5, the transmitter 36 and receiver 42 may be disposed in any of several locations on the substrate 16. Obviously, the examples shown in FIGS. 2-5 are not inclusive of all possible locations for the transmitter 36 and receiver 42. Numerous factors must be considered in determining the location of the transmitter 36 and receiver 42. These factors include, but are not limited to, a coverage area of the wiper blades 30, potential obstruction of a view of a driver of the vehicle 20, the frequency and amplitude of the transmitter signal 34 and wave, the material and thickness of the substrate 16, the dimensions of the piezoelectric elements 38, 46, and the dimensions of the coupler components 48, 50.

Referring again to FIG. 1, a phase shift detection circuit 56 is electrically connected to the receiver 42 and the signal generator 32. This phase shift detection circuit 56 measures a phase shift between the transmitter signal 34 and the receiver signal 44, as shown in FIG. 6. The phase shift may be described as a temporal phase shift, that is, the difference in time between the transmitter signal 34 and the receiver signal 44. Those skilled in the art realize that the signals 34, 44 and phase shift shown in FIG. 6 are illustrative in nature and that many variations can and do occur.

The transmitter signal 34 may be described having a cos(ωt) waveform, while the wave form on the receiver signal 44 is cos(ωt+Δ). The phase shift detection circuit 56 of the preferred embodiment may be implemented with a model number AD8302 phase magnitude detector chip from Analog Devices, Inc. However, other techniques for implementing the phase shift detection circuit will be realized by those skilled in the art.

Referring again to FIG. 1, in the preferred embodiment, a receiver amplifier 58 is electrically connected between the receiver 42 and the phase shift detection circuit 56 for amplifying the receiver signal 44. The receiver amplifier 58 may be a model number MAX4145 manufactured by Maxim Integrated Products, Inc. of Sunnyvale, Calif., however other suitable devices may be used. Of course, the receiver amplifier 58 may be integrated within the receiver 42 or the phase shift detection circuit 56. Furthermore, a band pass filter (not shown) may be electrically connected between the receiver amplifier 58 and the phase shift detection circuit 56. The band pass filter removes frequencies outside the targeted frequency generated by the signal generator 32, such as low frequency audio vibrations or high frequency RF signals.

Referring to FIG. 6, the phase shift between the transmitter signal 34 and the receiver signal 44 may be affected by a number of factors. These factors include the composition of the substrate and the distance between the transmitter and the receiver. Another factor is the presence of moisture 12 (or other foreign objects) on the substrate 16. The more moisture 12 on the substrate 16, the greater the phase shift between the transmitter signal 34 and the receiver signal 44. Thus, the amount of moisture 12 on the substrate 16 may be calculated.

Another factor that affects the phase shift is the temperature of the substrate 16. This significant factor is dependent on the frequency of the transmitter signal 34 and could, if not taken into account, adversely disrupt any calculation of the moisture 12 on the substrate 16 based on the phase shift between the transmitter signal 34 and the receiver signal 44. However, the temperature of the substrate 16 affects the phase shift in a reliable and repeatable way, thus allowing its affects to be taken into account.

Therefore, the sensor system 10 of the present invention also includes a temperature sensor 60 for sensing a temperature of the substrate 16. Numerous acceptable temperature sensors 60 are known to those skilled in the art, including thermocouples and resistance temperature detectors (RTDs), which may be operatively connected to the substrate 16, or infrared techniques, which may not require a connection to the substrate 16.

The sensor system 10 also includes a controller 62 in communication with the phase shift detection circuit 56 and the temperature sensor 60. The controller 62 senses the amount of moisture 12 on the surface based on the phase shift and the temperature of the substrate 16. Calculating the amount of moisture 12 on the surface is performed by analyzing the phase shift (time delay) and then compensating for the temperature of the substrate 16. In the preferred embodiment, the controller 62 is a microprocessor-based device, such as a microcontroller, running a software program. In the preferred embodiment, the controller 62 is implemented with a model number PIC16F876A microcontroller manufactured by Microchip Technologies, Inc., of Chandler, Ariz. Of course, other suitable controllers 62 may be utilized as known to those skilled in the art.

An analog-to-digital converter (ADC) (not shown) may be utilized to facilitate communications between the phase shift detection circuit 56 and the controller 62. Likewise, a digital thermocouple chip (not shown) may be utilized to facilitate communication between the temperature sensor 60 and the controller 62. The ADC and digital thermocouple chip may be separate, external components from the controller 62 or integrated within the controller 62.

The wiper motor 28 is preferably in communication with the controller 62. The controller 62 may activate the wiper motor 28 based on the amount of moisture 12 sensed on the outer surface 14 of the substrate 16. Specifically, the controller 62 will activate the wiper motor 28 if the amount of moisture 12 meets specific criteria. In the preferred embodiment, the wiper motor 28 is activated if the amount of moisture is greater than a threshold level. The threshold level is predetermined and stored in a memory (not shown) of the controller 62. The threshold level may be set by a user, be adaptive, or permanently fixed.

A window assembly 64 may be formed by the combination of the substrate 16 and the sensing system 10. The various components 48, 50 of the sensing system 10, particularly the transmitter 36, the receiver 42, the temperature sensor 60, the transmitter coupler component 48, the transmitter 36 receiver 42 component, the amplifiers 40, 58, the phase shift detection circuit 56, the controller 62, and the signal generator 32, may all be supported by the substrate 16. Specifically, a circuit board (not shown) may support the phase shift detection circuit 56, the controller 62, the signal generator 32, and the amplifiers 40, 58, and provide electrical interconnections for these devices. The circuit board may then be attached to the substrate 16. However, those skilled in the art realize other suitable locations for the circuit board and techniques for electrically interconnecting the devices.

Obviously, many modifications and variations of the present invention are possible in light of the above teachings. The invention may be practiced otherwise than as specifically described within the scope of the appended claims.

What is claimed is:

1. A sensing system for determining an amount of moisture on a surface of a substrate, said system comprising:
a signal generator for generating a transmitter signal;
a transmitter operatively connected to the substrate and electrically connected to said signal generator for producing a wave corresponding to the transmitter signal to propagate through the substrate;
a receiver operatively connected to the substrate and spaced apart from said transmitter for receiving the wave and generating a receiver signal corresponding to the wave;
a phase shift detection circuit electrically connected to said receiver and said signal generator for measuring a phase shift between the transmitter signal and the receiver signal;
a temperature sensor for sensing a temperature of the substrate; and
a controller in communication with said phase shift detection circuit and said temperature sensor and determining the amount of moisture on the surface based on the phase shift and the temperature of the substrate.

2. A sensing system as set forth in claim 1 wherein said transmitter comprises a transmitting piezoelectric element.

3. A sensing system as set forth in claim 1 wherein said receiver comprises a receiving piezoelectric element.

4. A sensing system as set forth in claim 1 further comprising a wiper motor in communication with said controller.

5. A sensing system as set forth in claim 1 further comprising a transmitter amplifier electrically connected between said signal generator and said transmitter for amplifying the transmitter signal.

6. A sensing system as set forth in claim 1 further comprising a receiver amplifier electrically connected between said receiver and said phase shift detection circuit for amplifying the receiver signal.

7. A sensing system as set forth in claim 1 wherein said signal generator generates the wave having a frequency in an ultrasonic range.

8. A sensing system as set forth in claim 1 further comprising a transmitter coupler component disposed between said transmitter and the substrate.

9. A sensing system as set forth in claim 8 further comprising a receiver coupler component disposed between the substrate and said receiver.

10. A sensing system as set forth in claim 9 wherein said transmitter coupler component includes a first directing surface angled relative toward said receiver for directing said transmitter toward said receiver.

11. A sensing system as set forth in claim 10 wherein said receiver coupler component includes a second directing surface angled relative toward said transmitter for directing said receiver toward said transmitter.

12. A window assembly comprising:
a substrate having an inner surface and an outer surface;
a signal generator for generating a transmitter signal;
a transmitter operatively connected to said substrate and electrically connected to said signal generator for producing a wave corresponding to the transmitter signal to propagate through said substrate;
a receiver operatively connected to said substrate and spaced apart from said transmitter for receiving the wave and generating a receiver signal corresponding thereto;
a phase shift detection circuit electrically connected to said receiver and said signal generator for measuring a phase shift between the transmitter signal and the receiver signal;
a temperature sensor operatively connected to said substrate for sensing a temperature of said substrate; and
a controller in communication with said phase shift detection circuit and said temperature sensor and sensing the amount of moisture on the outer surface based on the phase shift and the temperature of the substrate.

13. A window assembly as set forth in claim 12 wherein said substrate is further defined as at least one pane of glass.

14. A window assembly as set forth in claim 13 wherein said pane of glass is further defined as automotive glass.

15. A window assembly as set forth in claim 14 wherein said pane of glass is further defined as soda-lime-silica glass.

16. A window assembly as set forth in claim 12 wherein said substrate is further defined as a first pane of glass and a second pane of glass sandwiching a transparent polymer layer.

17. A window assembly as set forth in claim 12 wherein said transmitter comprises a transmitting piezoelectric element.

18. A window assembly as set forth in claim 12 wherein said receiver comprises a receiving piezoelectric element.

19. A window assembly as set forth in claim 12 further comprising a transmitter amplifier electrically connected between said signal generator and said transmitter for amplifying the transmitter signal.

20. A window assembly as set forth in claim 12 further comprising a receiver amplifier electrically connected between said receiver and said phase shift detection circuit for amplifying the receiver signal.

21. A window assembly as set forth in claim 12 wherein said signal generator generates the wave having a frequency in an ultrasonic range.

22. A window assembly as set forth in claim 12 further comprising a transmitter coupler component disposed between said transmitter and the substrate.

23. A window assembly as set forth in claim 22 further comprising a receiver coupler component disposed between the substrate and said receiver.

24. A window assembly as set forth in claim 23 wherein said transmitter coupler component includes a first directing surface angled relative toward said receiver for directing said transmitter toward said receiver.

25. A window assembly as set forth in claim 24 wherein said receiver coupler component includes a second directing surface angled relative toward said transmitter for directing said receiver toward said transmitter.
